(19) United States
(12) Patent Application Publication
(10) Pub. No.: US 2015/0088745 A1
(43) Pub. Date: Mar. 26, 2015

(54) ACCOUNT IDENTIFICATION

(71) Applicant: MasterCard International Incorporated, Purchase, NY (US)

(72) Inventors: Simon Phillips, York (GB); Alan Johnson, Essex (GB)

(21) Appl. No.: 14/496,210

(22) Filed: Sep. 25, 2014

(30) Foreign Application Priority Data
Sep. 26, 2013 (GB) 1317109.5

(51) Int. Cl. G06Q 20/22; G06Q 20/34; G06Q 20/40; G06Q 20/32

(52) U.S. Cl. CPC G06Q 20/22; G06Q 20/32; G06Q 20/34; G06Q 20/40
USPC 705/44; 705/39

(57) ABSTRACT

A method of account identification is performed on suitably programmed computing apparatus. An account number comprising a plurality of numeric characters is assigned to an account. The characters of the account number are divided into a numeric identifier and a convertible string. The convertible string is compressed into a compressed convertible string using an expanded character set. There are fewer characters in the compressed convertible string than in the uncompressed convertible string. A compressed account number is provided comprising the numeric identifier and the compressed convertible string. This may then be used in transactions without compromising the original account number while retaining the identifier for use in identifying transactions. A method of performing a transaction is also described, as is suitable apparatus for carrying out the methods described.

### CROSS-REFERENCE TO RELATED APPLICATION

This application is a U.S. National Stage filing under 35 U.S.C. §119, based on and claiming benefit of and priority to United Kingdom Patent Application No. 1317109.5 filed 26 Sep. 2013.

### FIELD

The invention relates to account identification. In aspects, the invention relates to efficient identification of accounts relating to transaction cards and display of account details.

Embodiments relate particularly to digitized transaction cards that do not have a physical equivalent, such as virtual payment cards installed on a mobile computing device such as a mobile telephone handset.

### BACKGROUND

Account numbers of any kind will generally have a standard format for that account. In the case of payment cards such as credit cards and debit cards, the Primary Account Number (PAN) is generally a 16 digit number, typically containing a Bank Identification Number (BIN), an account identifying string, and a check digit.

Until relatively recently, the PAN would be embodied in a physical (plastic) card that would in use always be read by a card reader or physically examined. Increasingly, payment cards are used in “customer not present” (CNP) transactions in which a PAN together with some set of credentials is provided over the public Internet or by telephone to establish a transaction. To allow transactions to be associated with a particular card in receipts and other widely visible media without revealing the PAN, a practice of PAN truncation has developed. In PAN truncation, the four least significant bits only of the PAN are used in the receipt to identify the card, with the other digits of the PAN not provided.

New types of virtual or digitized payments cards have now been developed which are intended only for interaction between digital devices interacting over some kind of network connection (this could be a local wireless connection or the public internet). These virtual cards are typically embodied within an application in a mobile computing device (such as a mobile telephone handset), and are generally associated with a cryptographic capability in the mobile computing device, such as a secure element with a cryptographic processor and protected memory for holding cryptographic keys. With such virtual cards, a transaction may only be allowed after a cryptographic exchange between payer and payee, with the type of CPN transaction described above (comprising provision of a PAN and some set of credentials) not permitted.

It would be desirable to deter any attempts to use virtual payment cards for inappropriate CPN transactions, both for user convenience and to prevent possible fraud. It would also be desirable for a PAN to be easier for a user to employ in contexts other than payment, such as calls to a customer service centre. The need to use a 16 digit PAN can cause these kind of interactions to be time consuming and more likely to contain errors.

### SUMMARY OF INVENTION

In one aspect, the invention provides a method of account identification comprising suitably programmed computing apparatus performing the steps of: receiving an account number comprising a plurality of numeric characters assigned to an account; dividing the characters of the account number into a numeric identifier and a convertible string; compressing the convertible string into a compressed convertible string using an expanded character set, wherein there are fewer characters in the compressed convertible string than in the uncompressed convertible string; and providing a compressed account number comprising the numeric identifier and the compressed convertible string.

This approach has more than one benefit. Firstly, the compressed account number is shorter, and so easier for a user to use, but retains the numeric identifier. Secondly, the replacement of the account number with a compressed account number obfuscates the account number to some degree, preventing the simple use of the account number for an inappropriate purpose.

In embodiments, the account number is a payment card account number, such as a PAN. In this case the numeric identifier may lie in the least significant digits of the PAN, and preferably the last four digits of the PAN as typically used in PAN truncation. This is particularly useful where the PAN is used for a virtual or digitised payment card used in a computing device, particularly in a mobile computing device such as a mobile telephone handset.

This implementation of the invention is both new and useful, as it allows the last four digits of the card account number to be displayed as part of the card number for consistency with receipts whilst preventing use of the card number for eCommerce, PAN key entered, MOTO and other transaction types.

This aspect of the invention allows the cardholder to more rapidly communicate the card/account identifier/number since it contains fewer characters than a typical 16 digit card number.

In one preferred arrangement, compressing the convertible string comprises rewriting the convertible string in another base. This may be, for example, Base 36, using all the digits and the characters of the regular Roman alphabet as characters.

In some preferred embodiments, compressing the convertible string comprises rewriting the convertible string using a restricted set of alphanumeric characters. For example, the algorithm for rewriting the convertible string may avoid the use of some characters that are easily confused and so may result in misunderstanding, for example 0 (zero) and O when printed and m and n, s and f, when spoken. A restricted set may thus exclude zero, m and f (for example) to prevent such confusion.

As indicated above, this approach is particularly suited for use with payment accounts that are to be loaded onto mobile phones, for example using MasterCard's MDES service. In such cases the payment card is digitised or virtual—typically a cryptographic exchange is needed for a transaction to take place. Where this is the case, the PAN itself is less sensitive, but it is still desirable to prevent attempts to use it inappropriately in CNP transactions. If the PAN is replaced in general use by a compressed PAN in which most of the PAN has been obfuscated, then this inappropriate use should be largely prevented.

In this case, compression and obfuscation of the PAN will be sufficient for general use—there may be little practical benefit in preventing the PAN from being reconstructed (reconstructing the PAN when it has simply been rewritten in another base is straightforward), as it will be used and revealed in transmission of transaction information around a financial system. In some other embodiments it may be desirable to keep knowledge of a full account number limited to some parties only—in such cases, it is possible to encrypt (rather than simply encode) the convertible string, with decryption only being possible for parties possessing a decryption key.

In a further aspect, the invention provides a computing device comprising a processor and a memory and suitably programmed to carry out a method as described above. This may be a mobile computing device, such as a mobile telephone handset. In preferred embodiments, the computing device comprises an application providing the functionality of a virtual payment card. The computing device may comprise a cryptographic capability, which may be comprised in a secure element.

### BRIEF DESCRIPTION OF FIGURES

Embodiments of the invention will now be described, by way of example, with reference to the accompanying Figures, of which:

FIG. 1 shows elements of a system suitable for carrying out embodiments of the invention;

FIG. 2 shows elements of a mobile telephone adapted to provide an embodiment of the invention;

FIG. 3 provides a flow diagram illustrating steps of a method of account identification according to an embodiment of the invention as broadly conceived; and

FIG. 4 provides a flow diagram illustrating an online transaction process according to an embodiment of the invention.

### DESCRIPTION OF SPECIFIC EMBODIMENTS

Specific embodiments of the invention will be described below with reference to the Figures.

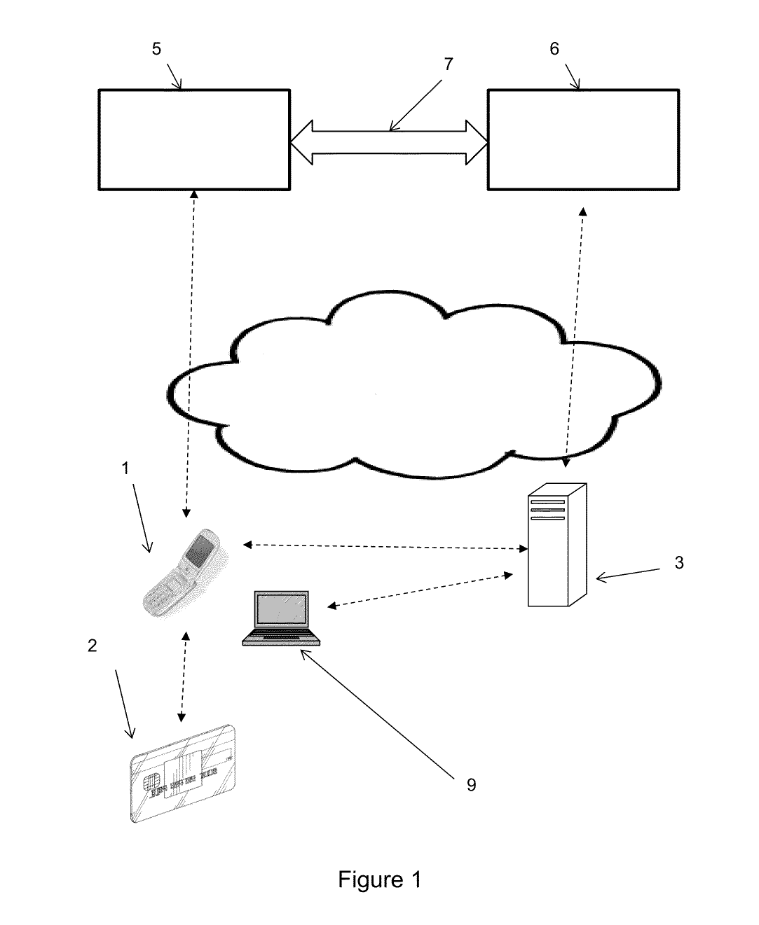

FIG. 1 shows schematically relevant parts of a representative transaction system suitable for implementing an embodiment of the invention. In the embodiments shown, a virtual or digitised payment card is used.

A user (not shown) is provided with a payment device—this may be for example a mobile phone 1 or a laptop 9. This payment device comprises either a virtual payment card, or a digitised version of a physical payment card 1. These devices typically have processors and memories for storing information including firmware and applications run by the respective processors. These devices are used with appropriate applications as payment card proxies, though they may also be used to allow credentials associated with a physical payment card 1 to be used in CNP transactions, for example by telephone or over the public internet. Payment card proxies will typically be equipped with means to communicate with other elements of a payment infrastructure over a computer network. Typically, a user will use a virtual or digitised payment card to communicate with a merchant over a telephonic or other connection to establish a CNP transaction. A remote merchant is here represented by a remote server 3 in telephonic communication with mobile telephone 1. The remote server 3 is typically connected or connectable to an acquiring bank 6 or other system in a secure way (either through a dedicated channel or through a secure communication mechanism over a public or insecure channel). There may also be a mechanism to allow connection between the user computer devices and a card issuing bank 5 or system associated with the user. A banking infrastructure 7 will also connect the card issuer 5 and the acquiring bank 6, allowing transactions to be carried out between them.

Embodiments of the invention are particularly relevant to digitized, or virtual, payment cards. Digitization of payment cards generally involves the loading of virtual cards into mobile phones and other (generally mobile) computing devices—for convenience, reference below will be made to mobile phones, but the discussion is as relevant to other types of computing device.

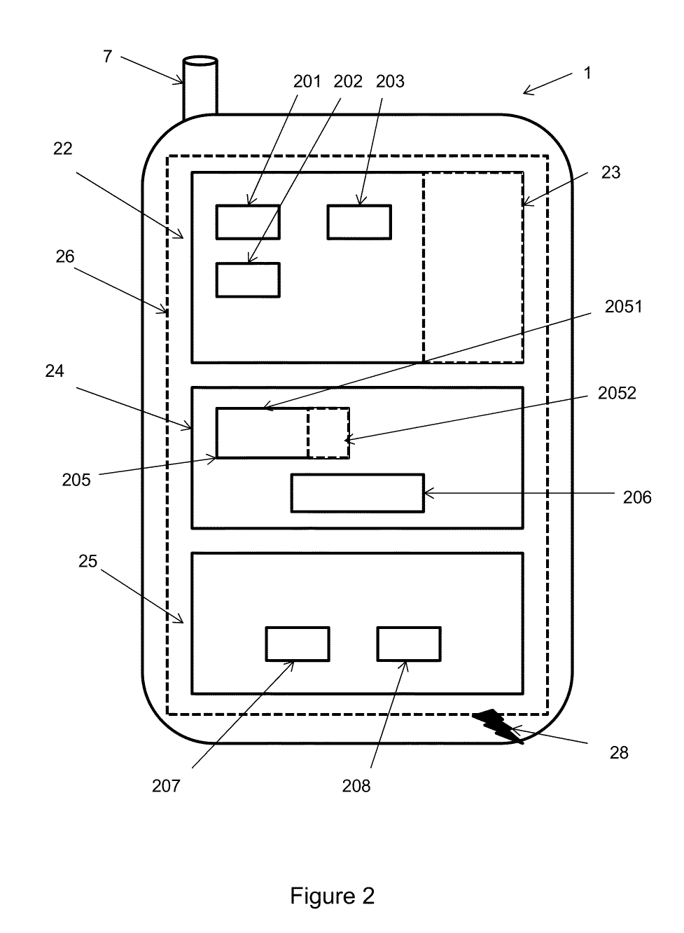

FIG. 2 shows schematically relevant parts of a representative hardware and software architecture for a mobile computing device suitable for implementing an embodiment of the invention. In the example shown, the mobile computing device is a mobile cellular telecommunications handset (“mobile phone” or “mobile device”)—in other embodiments, the computing device may be another type of computing device such as a laptop computer or a tablet, and the computing device need not have cellular telecommunications capabilities.

Mobile phone 1 comprises an application processor 22, one or more memories 23 associated with the application processor, a SIM, SE or USIM 24 itself comprising both processing and memory capabilities and a NFC controller 25. The terms SIM and USIM refer to Subscriber Identification Module and Universal Subscriber Identification Module respectively, and are standard terms of art in cellular telephony covered by appropriate GSM and UMTS standards—SE refers to a Secure Element, which is a tamper-resistant platform, normally implemented as a chip, capable of securely hosting applications and their confidential and cryptographic data The mobile phone also has a display 26 (shown as an overlay to the schematically represented computing elements of the device), providing in this example a touchscreen user interface. The mobile phone is equipped with wireless telecommunications apparatus 27 for communication with a wireless telecommunications network and local wireless communication apparatus 28 for interaction by NFC.

In the arrangement shown, the application processor 22 and associated memories 23 comprise (shown within the processor space, but with code and data stored within the memories) a associated mobile payment application 201 (which may be the applicant's Mobile PayPass, for example). It will also contain other applications normally needed by such a device, such as a browser 202 and a modem 203. The SE/SIM/USIM 24 comprises a security element 205 adapted to support cryptographic actions and an NFC application 206 which interfaces with the NFC controller 25, which has interfaces 207 to NFC devices and tags—this may also provide card emulation 208 to allow the mobile phone 1 to emulate a contactless card. Secure element 205 comprises secure processor 2051 and secure memory 2052.

As noted above, virtual cards are typically embodied within a payment application installed on the mobile phone. This may be a digital wallet application supported by a wallet service provider, for example. They may also be associated with a cryptographic capability within the phone—this may, for example, be provided within the secure element as a cryptographic processor and a secure memory for holding keys—and the virtual card may be usable only in transactions that involve a cryptographic authentication process or other cryptographic exchange.

At times, it may be necessary to identify the digital card account number or numbers used on a given phone or other computing device. The user may need to identify the digital card to the wallet service provider and the card issuer, for example in making a call to a customer service centre to report the loss of a card or to change credentials.

It is also desirable that a digital card number not be confused with plastic card numbers. These plastic card numbers may be used in remote payment and other CNP transactions by supply of the card number along with other credentials such as expiration date and CCV code. This is not an appropriate use model for virtual cards, and virtual cards will typically not be enabled for such transactions.

It is however desirable that transactions associated with virtual cards have a similar evidence trail to transactions with plastic transaction cards. It is therefore desirable for PAN truncation to be used in the same way as it is in plastic card transactions, which would mean that the last four digits printed on the receipt for a transaction would matches those displayed on the device/phone.

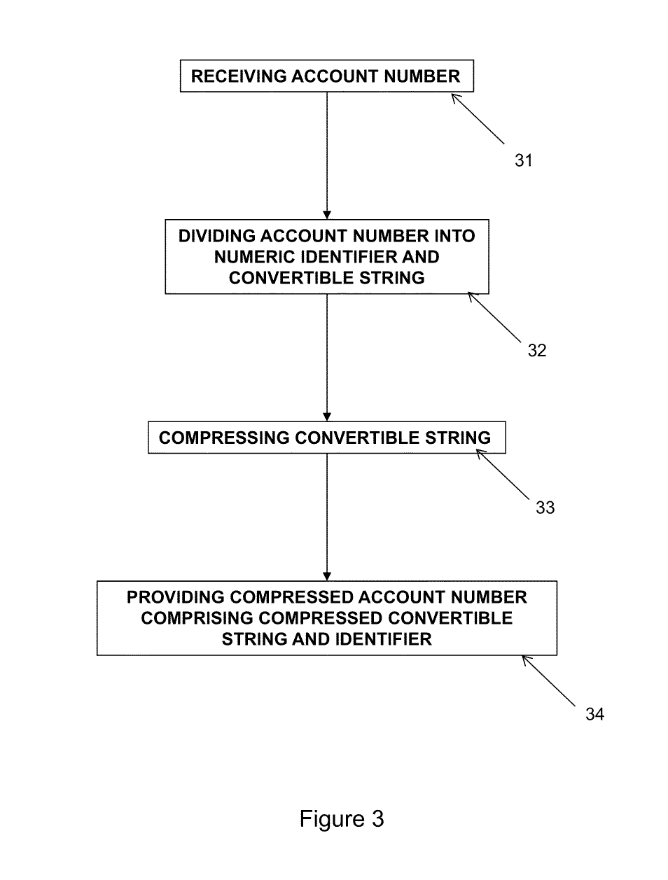

An method of account identification according to an embodiment of the invention as broadly conceived is shown in FIG. 3. The first step is to receive 31 an account number comprising a plurality of numeric characters assigned to an account. This may be, for example, on installation of a payment application on mobile phone 1. The next step is to divide 32 the characters of the account number into a numeric identifier and a convertible string. Typically, as described below, the numeric identifier will be the four least significant digits of the account number. The next step is to compress 33 the convertible string into a compressed convertible string using an expanded character set. There are fewer characters in the compressed convertible string than in the uncompressed convertible string. The final step is to provide 34 a compressed account number comprising the numeric identifier and the compressed convertible string. Typically the numeric identifier will retain the same position in the compressed account number (eg the four least significant digits, but in a shorter number).

This approach is particularly effective for use with virtual cards. A compression algorithm is applied to the most significant digits of the virtual card number. The virtual card number is divided into a convertible string and an identifier, the identifier comprising the last four digits used in PAN truncation. Preferably, the convertible string is converted into a new set of alphanumeric characters—generally these will not be entirely numeric and the number of characters will be reduced, preventing use of the card number in this form in remote transactions. The convertible string is however only encoded by a known and reversible encoding and not encrypted, so that it can be easily converted back to reconstruct the real virtual card number by the card issuer or other party that needs to know that number.

The simplest mechanism of this type is conversion into a new base, for example Base 36,in which case all 10 numerical digits and all 26 characters of the Roman alphabet will be used. Other encodings may in principle be used. The compressed card number will comprise a new, shorter, alphanumeric string, with only the last four digits in common with the virtual card number. For example:
5412 3456 7890 1234 would become 6WN135CI1234
5599 1234 7834 8365 would become 757XCSL68365
5412 3456 7890 1234 567 would become 5BUNQ7GJBF4567

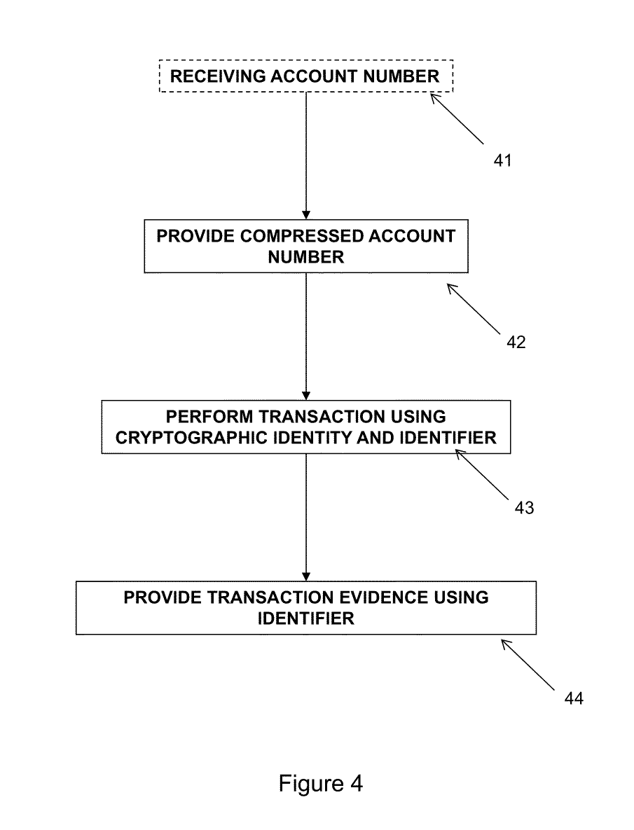

FIG. 4 shows the use of a compressed account number in transactions with a digitised or virtual payment card. The step of retrieving 41 an account number is shown as optional—the compressed account number may already have been generated well before the transaction itself. Typically, a transaction involving a digitised or virtual payment card will involve a cryptographic exchange using a cryptographic identity, and the account number itself will not be a necessary credential in the authorisation of the transaction itself. However, as discussed above, the evidence trail for a transaction will typically use the last four digits of the account number. By providing 42 the compressed account number, the transaction can be performed 43 using the cryptographic identity and at least the identifier (the compressed account number may be used if an account number is a required field for the transaction). As the identifier has been provided, this can be used 44 in evidence of the transaction such as an electronic receipt.

In addition to preventing use of the digital card identifier being used for remote (internet) payment transactions, the shortened identifier also makes it easier and faster for a user to communicate to any customer service staff that may need to identify the digital card concerned. As the virtual card number may be trivially reconstructed, this allows greater efficiency in interaction with the customer service centre.

A compressed card number may be constructed to be particularly easy to use in a call centre context by choice of an appropriate character set for encoding. A preferred character set avoids the use of both members of a potentially confusing pair (such as zero and O, M and N, or F and S). Encoding into Base 33 without use of O, M or F, for example, reduces further the risk of errors or confusion without significant loss in compression.

Where the virtual card can only be used with a cryptographic exchange, the display of a compressed PAN without cardholder verification being required provides benefits to the user without any significant security risk. This would mean that a phone could display cards in a wallet with the full coded PAN/card number at all times, allowing the user to easily access the card identifier should they need to do so. For example, when a cardholder forgets a PIN, he or she can easily access the identifier to allow the customer service staff to quickly identify the account or card with which they have a problem.

In aspects, embodiments of the invention include a mobile computing device such as a mobile phone adapted to convert between a compressed and uncompressed card number using the approach indicated above. In the context described above, this will typically be provided within or with a virtual card application such as a digital wallet.

In some contexts, it may be desirable to limit knowledge of the full account number to certain parties—for example, for a merchant card which is designed to have an account number known only to a set of parties within its own financial network. In cases like this, the convertible string may be encrypted with an encryption key rather than simply encoded. The decryption key, and so the capability to reconstruct the true account number, may be possessed or accessed only by these authorised parties.

This approach may be used for other account types, rather than simply for virtual payment cards. Other customer accounts (such as utility provider accounts) may need to be in numerical form for some purposes, but may benefit from being shortened to a compressed form for customer service purposes, particularly where this also involves elimination of confusing characters.

Other variations and modifications may be made within the spirit and scope of the invention as described.

1. A method of account identification comprising suitably programmed computing apparatus performing the steps of:
receiving an account number comprising a plurality of numeric characters assigned to an account;
dividing the characters of the account number into a numeric identifier and a convertible string;
compressing the convertible string into a compressed convertible string using an expanded character set, wherein there are fewer characters in the compressed convertible string than in the uncompressed convertible string; and
providing a compressed account number comprising the numeric identifier and the compressed convertible string.

2. The method of claim 1, wherein the account number is a payment card account number.

3. The method of claim 2, wherein the numeric identifier comprises least significant digits of the payment card account number.

4. The method of claim 3, wherein the numeric identifier comprises a last four digits of the account number.

5. The method of claim 2, wherein the payment card account number is the account number of a virtual or digitised payment card used in the computing apparatus.

6. The method of claim 5, wherein the computing apparatus is a mobile telephone handset.

7. The method of claim 1, wherein compressing the convertible string comprises rewriting the convertible string in another base.

8. The method of claim 1, wherein the another base is base 36, and the expanded character set comprises all the digits and the characters of the regular Roman alphabet.

9. The method of claim 1, wherein the expanded character set does not comprise all the digits and the characters of the regular Roman alphabet.

10. The method of claim 9, wherein the expanded character set does not comprise characters determined to be phonetically similar.

11. The method of claim 1, wherein compressing the convertible string comprises reversibly encoding the convertible string to form the compressed convertible string.

12. The method of claim 1, wherein compressing the convertible string comprises encrypting the convertible string to form the compressed convertible string.

13. A method of performing an online transaction with a digitised or virtual payment card stored on computing apparatus, comprising:
providing a compressed account number from an account number for the virtual payment card, wherein the account number comprises a plurality of numeric characters, by dividing the characters of the account number into a numeric identifier and a convertible string, compressing the convertible string into a compressed convertible string using an expanded character set, wherein there are fewer characters in the compressed convertible string than in the uncompressed convertible string, and providing a compressed account number comprising the numeric identifier and the compressed convertible string;
performing an online transaction using a cryptographic identity and the compressed account number; wherein the numeric identifier is provided in evidence of the transaction.

14. The method of claim 13 wherein the computing apparatus is a mobile telephone handset.

15. The method of claim 13 wherein compressing the convertible string comprises encrypting the convertible string to form the compressed convertible string.

16. A computing device comprising a processor and a memory, wherein the processor is programmed to provide a compressed account number from an account number, wherein the account number comprises a plurality of numeric characters, by dividing the characters of the account number into a numeric identifier and a convertible string, by compressing the convertible string into a compressed convertible string using an expanded character set, wherein there are fewer characters in the compressed convertible string than in the uncompressed convertible string, and by providing a compressed account number comprising the numeric identifier and the compressed convertible string.

17. The computing device of claim 16, wherein the computing device is a mobile telephone handset.

18. The computing device of claim 17, wherein the processor is programmed with a mobile payment application and the account number is the account number of a virtual or digitised payment card.

19. The computing device of claim 18, wherein the mobile payment application is adapted to transact using a cryptographic identity.

20. The computing device of claim 19, wherein the computing device comprises a secure element comprising the cryptographic identity.
